(19) United States
(12) Patent Application Publication
(10) Pub. No.: US 2013/0215426 A1
(43) Pub. Date: Aug. 22, 2013

(54) METHOD AND APPARATUS FOR ANALYTE DETECTION

(71) Applicants: Ash Kaushal, Mississauga (CA); Duncan MacIntyre, Campbellville (CA)

(72) Inventors: Ash Kaushal, Mississauga (CA); Duncan MacIntyre, Campbellville (CA)

(73) Assignee: NIR SCIENCE CORPORATION, Campbellville, ON (CA)

(21) Appl. No.: 13/814,188

(22) PCT Filed: Aug. 4, 2011
(86) PCT No.: PCT/CA2011/050475

§ 371 Date: Mar. 14, 2013

Related U.S. Application Data
(60) Provisional application No. 61/370,687, filed on Aug. 4, 2010.

(51) Int. Cl. G01N 21/59; G01N 21/55

(52) U.S. Cl. CPC G01N 21/59; G01N 21/55
USPC 356/436; 356/445; 356/432

(57) ABSTRACT

A photo-spectroscopic analytic device is given for detecting analytes in a sample. The analyte may be microbial pathogen, a food sample, a sample of a body fluid, water, or a combination thereof. The device comprises an electromagnetic radiation (EMR) source in operative communication with one or more optic inputs, one or more receptors for receiving one or more sample holders, each receptor comprising one or more of the optic inputs which are operatively coupled to one or more optic outputs thereby forming an optic input-optic output pair. Each of the receptors may comprise different cross-sectional profiles corresponding to cross-sectional profiles of the sample holders.

### TECHNICAL FIELD

The present invention relates to methods and apparatus for detecting one or more analytes in one or more sample. The analyte may be a microbial pathogen, a food sample, a sample of body fluid, water, or a combination thereof.

### BACKGROUND

Current methods of detection of food, water and airborne pathogens or analytes within food or body fluid samples are generally reagent-based, and may require the use of specialized lab equipment. Further, identification of a microbe may require that the microbe be isolated and cultured.

Detection and identification of substances by infrared (IR) and Raman spectroscopy is well-established. The IR or Raman spectrum of a substance is characterized by a unique pattern of absorption bands that reflects the physic-chemical environment of the chemical functional groups comprising the substance. Non limiting examples of such methods include U.S. Pat. No. 7,198,955, U.S. Pat. No. 7,157,282, U.S. Pat. No. 6,741,876, U.S. Pat. No. 6,651,015, U.S. Pat. No. 6,611,777, U.S. Pat. No. 5,459,677, U.S. Pat. No. 5,429,128, (which are incorporated herein by reference).

Various studies have demonstrated the feasibility of detection and identification of bacteria using infrared spectroscopy. Fourier-transform mid-infrared (FT-IR) spectroscopy has been use to detect and classify bacteria (Naumann D., et. al., Nature. 1991, 351(6321):81-2; Helm D., J Gen Microbiol. 1991, 137(1):69-79), and detect bacteria in meat (Ellis D. I., Appl Environ Microbiol. 2002, 68(6):2822-8). FT-IR has also been used to detect pure cultures of bacterial pathogens inoculated into bottled drinking water (Al-Qadiri H. M., J Agric Food Chem. 2006, 54(16):5749-54).

Devices and methods that enable real-time detection and identification of bacterial pathogens or other analytes are desired, to determine sources of contamination, and appropriate public health measures taken.

### SUMMARY OF THE INVENTION

The present invention relates to methods and apparatus for detecting one or more analytes in one or more sample. The analyte may be a microbial pathogen, a food sample, a sample of a body fluid, water, or a combination thereof.

The present invention provides a device for determining information of, obtaining information for, or detecting, one or more analytes in one or more samples. The device comprising:

an electromagnetic radiation (EMR) source operatively coupled to a power source, the EMR source in operative communication with one or more optic inputs, each of the one or more optic inputs emitting one or more wavelengths of EMR,

one or more receptors for receiving one or more sample holder, each of the one or more receptors comprising one or more of the one or more optic input operatively coupled to one or more optic output thereby forming an optic input-optic output pair, each of the optic input-optic output pair receiving one or more wavelengths of EMR,

a detector operatively coupled with each of the one or more optic output, the detector for measuring transmitted or reflected EMR received from a sample when placed in the sample holder and the sample holder placed within the receptor, the detector producing a signal output comprising the obtained information.

The device as described above may further comprise a processing system operatively coupled to the signal output of the device, the processing system comprising one or more calibration algorithms for detecting the identity, concentration, or a combination thereof, of the one or more analytes in the sample. The processing system may be operatively coupled to the signal output via a hard wire connection or the device configured with a USB or other port for a connection between the signal output and processing system. The device may also comprises a transmitter that receives the output signal and transmits the output signal via a wireless connection to a processing system. The device may also comprise a screen as a user interface for providing operational instructions to the device or processing system, and/or for displaying a result obtained from the processing system the result comprising the identity concentration, or a combination thereof of the one or more analytes in the sample.

The device as described above may be portable, or hand-held.

Each of the receptors of the device as described above may comprise different cross-sectional profiles, so that each of the cross-sectional profiles of the receptors corresponds with a cross-sectional profile of the sample holder. Alternatively, each of the one or more receptors may be shaped to receive one or more sample holders, each sample holder having a different cross-section profile, and each of the one or more receptor comprises one or more selection mechanisms to activate a pre-set one or more wavelength of EMR to pass through a sample when each of the one or more sample holders is inserted within the receptor.

As a further alternative, the one or more receptors may be shaped to receive one or more sample holders, each sample holder comprising a plurality of sample wells. The one or more optic input-optic output pairs within the one or more receptors is positioned within the receptor so that they are in optical alignment with each of the plurality of sample wells of the sample holder when the sample holder is inserted into the receptor.

The device as described above may further be configured to track an identifier associated with each sample holder. In this way, the one or more receptors may be configured to direct the one or more wavelengths of EMR towards each sample contained in each one or more sample holder based upon the identifier associated with each of the one or more sample holders. Additionally, the device may be configured to apply an identifier to each of the one or more sample holders inserted in the device; and reject sample holders that have been previously presented to the device.

The present invention also provides a method for identifying one or more analyte in one or more sample, the method comprising, inserting each of the one or more sample into one or more sample holders, placing each of the one or more sample holders within each of the one or more receptors of the device as defined above and identifying the one or more analyte in the sample. The one or more analyte may be a pathogen, a bacteria, or a compound. The sample may also be a biological or non-biological fluid, a biological or non-biological semi-solid, or a biological or non-biological solid, a water sample, a sample of whole blood, serum, plasma, urine, synovial fluid, lymphatic fluid, sputum, feces, cerebrospinal fluid, a dairy product, milk, cheese, yogurt, ice cream, wine, a beverage, or semi soft food.

Furthermore, the present invention provides the device as defined above, wherein the processing system is located within the device, or it is located at a distance from the device. The processing system may be hard-wired to the signal output of the detector, or the processing system may be in wireless communication with the signal output of the detector of the device. If the processing system is located at a distance from the device and is in wireless communication with device, then the device further comprises a transmitter and a receiver for sending the signal output to the processing system and receiving the result from the processing system, respectively, and the processing system comprises a receiver for receiving the signal output from the detector, and a transmitter for sending the result to the device for display on the screen.

The present invention also provide a device for determining information for one or more analytes in a sample, comprising,

an electromagnetic radiation (EMR) source operatively coupled to a power source, the EMR source in operative communication with one or more optic inputs, each of the one or more optic inputs emitting two or more wavelengths of EMR,

a receptor for receiving a sample holder, the receptor operatively coupled with one or more of the one or more optic inputs and one or more optic output, each of the one ore more optic inputs and one or more optic outputs of the receptor operatively coupled to provide an optic input-optic output pair for each of the one or more wavelengths of EMR, each of the one or more optic inputs operatively coupled with a receptor and transmitting a unique wavelength or unique combination of wavelengths of EMR to the receptor, the unique wavelength or unique combination of wavelengths selected by insertion of the sample holder having a specific cross-sectional area, width, length or a combination thereof, within the receptor,

a detector operatively coupled with each of the one ore more optic output, the detector for measuring transmitted or reflected EMR received from a sample when placed in the sample holder, the detector producing a signal output,

the signal output operatively coupled to a processing system comprising one or more calibration algorithms for determining the information, the information comprising an identity, a concentration or a combination thereof of the one or more analytes in the sample, and

a screen for displaying a result obtained from the signal output comprising the information for the one or more analytes in the sample.

The EMR source may be comprised of an array of light emitting diodes (LEDs), or lasers where one or more of the LEDs or lasers of the array is operatively coupled with one optic input, and each LED or laser of the array emitting a desired wavelength of EMR.

By placing the sample within a specific chamber, or receptor, one or more wavelength of EMR may be selected and used for determination of an analyte within the sample. For example, one of the chambers may be configured to receive a sample holder having a set path-length and a set one or more wavelengths of EMR, a second chamber configured for a different one or more wavelengths, and a similar or different path-length as needed. Additionally, one receptor may be used that is configured to accept a sample holder having a variety of wells or sample holders of a variety of shapes. In this manner a specific wavelength or combination of wavelengths of EMR may be transmitted to a sample within the sample holder for the analysis of a desired analyte.

The present invention provides, at least in part, a device for detecting one or more analytes in one or more samples contained in one or more sample holders, comprising:

an electromagnetic radiation (EMR) source configured to emit EMR of at least two different wavelengths;

one or more receptors in optical communication with the EMR source, the receptors configured to receive the sample holders and direct EMR received from the EMR source towards the samples contained in the sample holders, the receptors configured to direct EMR towards at least one sample having a different wavelength or wavelengths than the EMR directed towards at least one other sample; and

a detector in optical communication with the receptor and in communication with a processing system, the detector configured to measure the EMR transmitted, reflected, or scattered by each sample, and communicate the measured EMR to the processing system, the processing system configured to detect one or more analytes in the samples.

The receptors may be configured to direct EMR having a specific wavelength or wavelengths towards each sample contained in a sample holder based upon one or more characteristics of the sample holder. The device may comprise at least two receptors comprising different cross-sectional profiles corresponding to cross-sectional profiles of different sample holders, and each of the at least two receptors may be configured to solely accept sample holders having a cross-sectional profile corresponding to the cross-sectional profile of the receptor.

At least one receptor may be configured to:

accept sample holders having different cross-section profiles;

detect the cross-sectional profile of each sample holder; and

direct EMR having a specific wavelength or wavelengths towards each sample contained in each sample holder based upon the cross-sectional profile of the sample holder.

Each receptor may be configured to direct EMR having a specific wavelength or wavelengths towards each sample contained in each sample holder based upon an identifier associated with the sample holder. The device may be configured to: apply an identifier to each sample holder presented to the device; and reject sample holders that have been previously presented to the device. The identifier associated with each sample holder may be a unique identifier; the device may be configured to track the unique identifier of each sample holder presented to the device; and the device may be configured to reject sample holders that have been previously presented to the device. The identifier may be a bar code. The identifier may be a particular combination of the presence or absence of samples at particular locations on the sample holders; and the receptor may be configured to detect the presence or absence of sample at the particular locations on the sample holders.

The device may further comprise the processing system. The device may further comprise a transmitter for communicating to a remote system information respecting one or more analytes in the samples determined by the processing system.

Alternatively, the processing system may be located remotely to the device; and the device may further comprise a transmitter for communicating the measured EMR to the processing system. The device may further comprise a receiver for receiving information respecting one or more analytes in the samples determined by the processing system and communicated to the device by the processing system.

The device may further comprise a unique color coding for each receptor corresponding to a color coding of the sample holders that the receptor is configured to receive.

This summary of the invention does not necessarily describe all features of the invention. Other aspects, features and advantages of the present invention will become apparent to those of ordinary skill in the art upon review of the following description of specific embodiments of the invention.

### BRIEF DESCRIPTION OF THE DRAWINGS

These and other features of the invention will become more apparent from the following description in which reference is made to the appended drawings wherein:

FIG. 1A shows a perspective view of a non-limiting example of a device according to the present invention.

FIG. 1B shows a cross sectional view of the device of FIG. 1A.

FIG. 2 shows a schematic diagram of an example of a device as described herein.

FIG. 3 shows a non-limiting example of an alternate device according to the present invention

FIG. 4 shows non-limiting examples of alternative sample holders according to the present invention.

FIG. 4A shows a sample holder with sample wells connected in series.

FIG. 4 B shows a sample holder with sample wells connected in parallel.

### DETAILED DESCRIPTION

The present invention relates to methods and apparatus for detecting one or more analytes in one or more sample. The analyte may be a microbial pathogen, a food sample a sample of a body fluid, water, or a combination thereof.

Use of examples in the specification, including examples of teems, is for illustrative purposes only and is not intended to limit the scope and meaning of the embodiments of the invention herein. Numeric ranges are inclusive of the numbers defining the range. In the specification, the word “comprising” is used as an open-ended term, substantially equivalent to the phrase “including, but not limited to,” and the word “comprises” has a corresponding meaning.

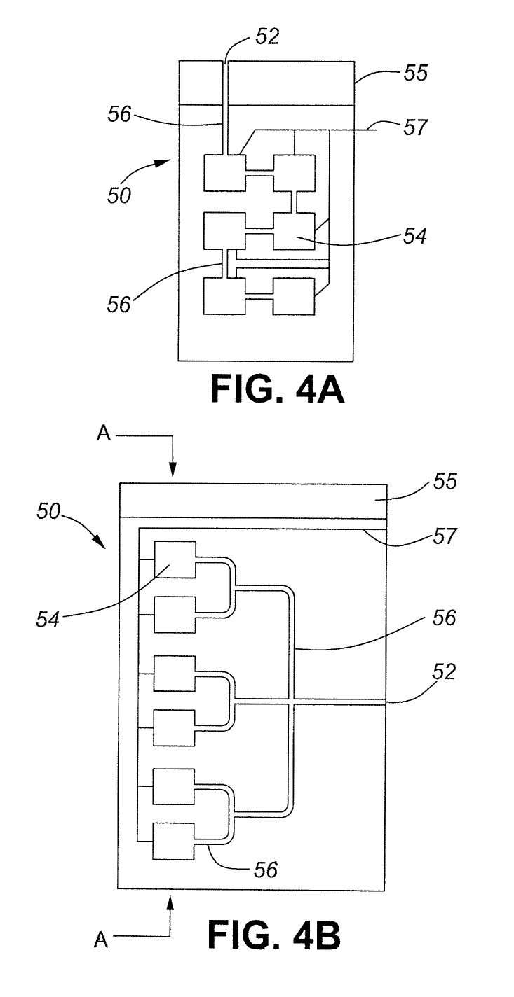

The present invention provides at least in part, a device for determining information for one or more analytes in a sample. With reference to the Figures the device (35) comprises, a source of electromagnetic radiation (EMR; 10) operatively coupled to a power source (20), for example but not limited to a battery, a solar powered battery, an electrical source, or other suitable power source. The EMR source (10) is operatively coupled with one or more optic inputs (15). Each optic input (15) directs the EMR from the EMR source (10) to a receptor (30), so that when a sample holder, comprising one or more sample wells (54; see FIGS. 4A, 4B) within is placed within the receptor, each of the one or more optic inputs emits one or more wavelengths of EMR within the receptor(s) of the device (35). The optic input (15) may be one ore more fiber optic cable or other device capable of directing EMR.

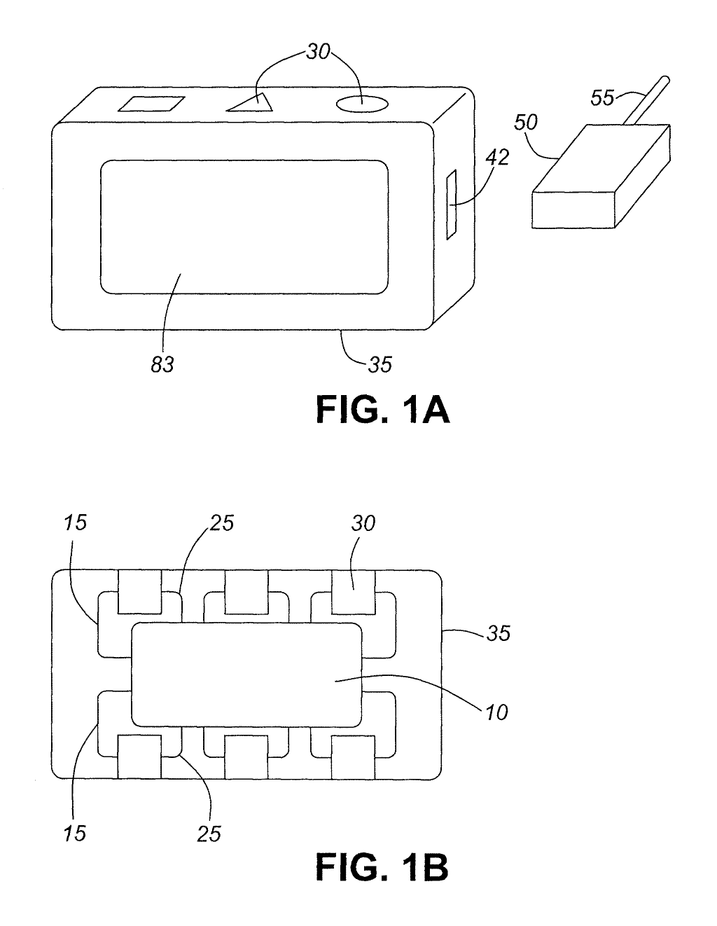

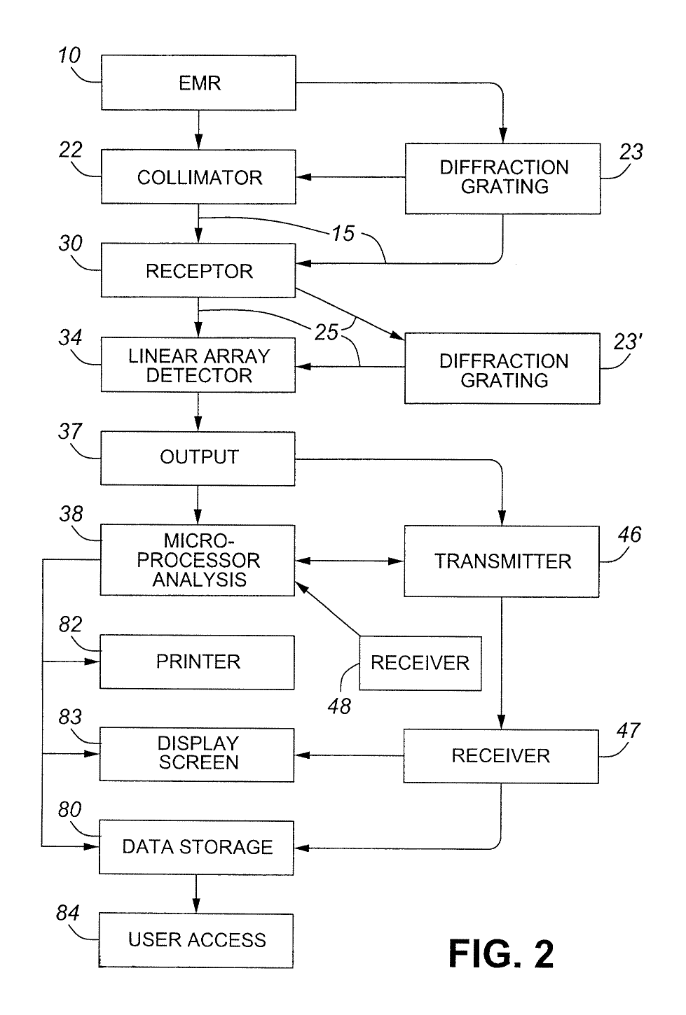

The device may comprise one, or a plurality of receptors (30), for example which is not to be considered limiting 1, 2, 3, 4, 5, 6, 7, 8, 9, 10, 12, 14, 16, 18, or 20 receptors. A non-limiting example of a device with 6 receptors is shown in FIG. 1B. Each of the one or more receptors (30) is configured to receive a sample holder (50). Each sample holder may comprise one or more sample wells (54; see FIGS. 4A, 4B). Each receptor is operative coupled with an optic output (25), so that each of the one ore more optic inputs (15) and each of the one or more optic outputs (25) are operatively coupled to provide an optic input-optic output pair for each of the one or more wavelengths of EMR. With this arrangement one or more wave length of light from the EMR (10) passes through the optic input (15), and sample located within a sample well (54) of a sample holder (50) placed within a receptor (30), and out via the optic output (25) of the optic input-optic output pair, to a linear array detector (34; see FIG. 2). The optic output (25) may be one ore more fiber optic cable or other device capable of directing EMR. There may be one or more optic inputs (15) and one or more optic outputs (25) supplying EMR into and receiving EMR from, a receptor (30).

For example, which is not to be considered limiting, the device (35) may comprise six receptors (30), each receptor configured to receive a different, or a unique wavelength or unique combination of wavelengths, of EMR via one or more optical inputs (15), so that a plurality of analytes may be detected in six samples when inserted within the receptors. The six samples may be the same or different. For example, which is not to be considered limiting, one receptor (30) may be configured within an optic input (15) carrying wavelengths of 678 nm and 721 nm, and a second receptor (30) configured within an optic input (15) carrying 678 nm and 452 nm, so that each of the six receptors receives a unique wavelength or combinations of wavelengths of EMR. In this way, for example, a sample of blood may be analyzed in one sample holder, when inserted into the appropriate receptor (30), and urine analyzed in a second sample holder when inserted within an appropriate receptor (30). Alternatively, the same sample may be inserted within more than one sample holder (50) and placed within different receptors (30) of the device (35). If the device comprises one receptor (30) that is designed to receive a plurality of sample holders (50) with different cross-sectional areas or profiles (described in more detail below), then insertion of one sample holder having a specific cross-sectional area or profile, for example a circular cross-section profile, may activate one set of wavelengths, for example 678 nm and 721 nm, and insertion of a second sample holder into the same receptor (30), having a different cross-sectional profile, for example a trapezoid cross-section area, may activate a second set of wavelengths, for example 678 nm and 452 nm. In this way, for example, a sample of blood may be analyzed in one sample holder, when inserted into the receptor (30), and urine analyzed in a second sample holder when inserted within the same receptor (30). Alternatively, the same sample may be inserted within more than one sample holder (50), each having a different cross sectional profile, and each of the holders placed within the receptor (30) of the device (35) so that different analytes of the sample may be identified.

An optic input (15)-optic output (25) pair may be placed at opposite sides of the receptor so that EMR (10) is directed through a sample placed within the receptor (30), and the optic output (25) receives transmitted EMR after it passes through the sample. The optic input-optic output pair may also be placed at an angle relative to each other, for example from about 0° to about 180°, or any angle therebetween, so that the optic output (25) receives reflected or scattered EMR from a sample when placed within the receptor (30). If the optic input-optic output pair is oriented at an angle that is about 0° relative to each other, then the optic input (15) and optic output (25) may be arranged concentrically so that, for example, the optic input is positioned centrally within an optic fiber, and the optic output placed concentrically about the optic input. The optic output may also be placed centrally, and the concentric fiber may comprise the optic input.

The reflected and/or transmitted EMR following interaction with the one or more compounds or analytes in the sample may be collected by the optic output (25), which may comprise fiber optics, and the output EMR directed to a diffraction device (23′) that separates the wavelengths of light within the output EMR into component parts, or a filter, for example one or more interference bandpass filters, that permits selected wavelengths of EMR to pass through the filter. The present invention is not to be limited by the type of diffraction device or filter used as variants are known to one of skill in the art. Examples of a diffraction device may include a diffraction grating or a holographic grating, as are known in the art. The diffraction device may disperse the output EMR so that the dispersed, output EMR falls along the length, or over the area, or a detector (34). Examples of a detector (34) include a linear array detector (e.g. a photodiode array) or a CCD (charge couple device). The present invention is not to be limited by the type of detector used as variants are known to one of skill in the art. Where the detector (34) comprises an array, the array comprises a series of diodes and may be electronically scanned by a microprocessor to measure the charge accumulated on each diode, the charge being proportion to the intensity of output EMR for each wavelength transmitted through, or reflected from, the one or more compounds in the sample.

The detector (34) receives transmitted or reflected EMR from the sample, and produces a output signal (37). The output signal may be operatively coupled to a processing system (38) comprising one or more calibration algorithms for determining the information about the sample, for example, the information may comprise an identity, a concentration or a combination of an identify and a concentration of one or more analytes in the sample. However, the device may comprise the power source (20), EMR source (10), receptor (30) coupled with an optic input (15) and optic output (25) pair, a detector and an USB (42) or similar port, or a transmitter (46). With this arrangement, the output signal is not processed in the device (35), but transmitted to another unit for processing.

The detector (34) may comprise a photodetector in combination with one or more interference bandpass filters, or diffractive optics (23′), to achieve wavelength differentiation, as is known in the art. Alternatively, the detector (34) may comprise a one or two dimensional photodiode array. Such an array may comprise discrete units, or ‘pixels’, for example which is not to be considered limiting, comprising silicon photodetectors, with single-layer thin films. Each of the thin films of has a known absorption coefficient, and the absorption coefficient may be different for each of the filters. One pixel, configured to receive a specific wavelength of EMR may also be used. Incident EMR passes through the filter to reach the photodetector, generating a signal, which is transmitted to a microprocessor (38). Methods for making such photodetectors are described in, for example U.S. Pat. No. 7,345,764 to Bulovic et al.

The detector (34) is operatively coupled with a processing system (38) comprising a microprocessor, and if desired, a data storage device (80). Data processing of the output signal (37) may comprise one or more than one calibration algorithms (for example, as disclosed in U.S. Pat. No. 6,651,015) that may be used to determine a property of one or more than one compound or analytes in the sample, or one or more compounds or analytes in multiple samples.

The concentration of a given compound may be calculated by using a calibration equation derived from a statistical analysis, e.g. least squares best fit, of a plot of the value of concentration of a calibration set of samples of the compound (determined using known methods, for example U.S. Pat. No. 6,651,015; which is incorporated by reference). Other statistical tests that may be used include, but are not limited to, multiple linear regression, partial least squares or the like). Any known method for determining the concentration of one, or more than one compound may be uses, as would be known to one of skill in the art. Alternately, the percent value of the one or more than one compounds may be determined from a calibration table comprising predetermined values. Such calibration tables may be prepared using a range of given absorption (or transmission) values, and related to compositions comprising a known percentage of the compound, so that the absorption (or transmission) reading is related to a known percentage of the compound, thus removing the need for mathematical manipulation. The calibration algorithm or related software (e.g. presentation software; calibration tables or data) may also be imported into the processing system (38) located in the device (35) or at a remote location from the device (35). The calibration algorithm may be up-loaded from a remote source to the device or remote location via hard-wire or a wireless manner (via receiver 48; FIG. 2), for example as an “app” (application software). In this way the processing software can be updated, for example to include additional analyte analysis, or calibration tables with increased accuracy, and a user can obtain updates of the calibration algorithm or processing software to be imported to the processing system (38).

The processing system (38) may be located within the device (35), or it may be located at a distance from the device. For example, the processing system (38) may be hard-wired to the output signal (37) of the detector (34), or the processing system may be in wireless communication with the output signal of the detector of the device. If the processing system (38) is located at a distance from the device (35) and is in wireless communication with device (35), then the device may further comprises a transmitter (46) and optionally a receiver (47) for sending the output signal (37) to the processing system (38) and receiving the result from the processing system, respectively, and the processing system may comprise a receiver for receiving the signal output from the detector, and a transmitter for sending the result to the device for display on the screen. However, the device (35) can be configured so that it only transmits the output signal (37) to a remote processing system. For example, the processing system may be located at a lab, hospital, doctors office or a secure network operating center (NOC), and the processing system (38) configured so that it receives the output signal (37). The processing system (38) may also be shared with the processing capability of another monitoring system as desired. The data obtained from the processing system may either be stored at the same site (80) as where the remote processing system (38) is located, for example, the lab, hospital, doctors office, or NOC, or the data may be stored at a separate facility (80). If the data is stored at an NOC, then designated users may have access to the data. For example, the results may be processed at a doctors office, hospital, or lab via a processing system (38), and the data sent to an NOC for storage (80) and access (84) by third parties via hard wire, or wirelessly, as needed. Alternatively, the output signal (37) may be sent from a doctors office, hospital, or lab to an off-site processing system (38), which may or may not be located at an NOC, and the data (80) either sent to an NOC for storage or sent to an NOC for processing and storage, and access (84) by third parties, via hard wire, or wirelessly, as needed.

Where the processing system (38) is located within the device (35), the device (35) may also comprise a transmitter (46) for sending the result from the processing system (38) to a remote system, for example, a lab, hospital, doctors office or network operating center. The result from the processing system (38) may be sent to the remote system through, one or more networks, and using one or more wired or wireless communication methods known in the art.

Processing software for use in the processing system (38) located in the device (35) or at a remote location from the device (35) may be introduced to the processing device (38) via receiver (48) from a remote location. Processing software may include one or more calibration algorithms, calibration tables, calibration data, presentation software, or a combination thereof. And may be imported for example as an “app” (application software).

The output signal (37) comprising information about one or more analytes in the sample can be displayed on a screen (83), sent to a printer (82), or stored on a memory medium (80), for example but not limited to, flash memory, CD or DVD, tape, or other device for subsequent analysis via a connection port, for example a USB port (42; FIG. 1). The screen (83), printer (82), memory medium (80) may also be shared with another monitoring system (84) as desired.

The screen (83) may also be used as a user interface to present options to a user, and receive instructions from the user, for example, to select desired information to be obtained using the device.

The EMR source (10) may be comprised of an array of light emitting diodes (LEDs), where one or more of the LEDs of the array is operatively coupled with one optic input (15), and each LED of the array emitting a desired wavelength of EMR. In this manner, an optic input (15) is coupled with one or more wavelengths of EMR that can be used for determining the analyte of a sample inserted within a receptor (30) of the device (35). Alternatively, the EMR may emit a range of wavelengths, and the EMR may pass through one or more filters, each filter of the one or more filters selectively passing desired wavelengths of EMR to the optic input (15), so that an optic input is coupled with one or more wavelengths of EMR that can be used for determining the analyte of a sample inserted within one of the receptors of the device (35). Furthermore, the EMR may emit a range of wavelengths, and the EMR pass through a diffraction grating (23), and desired wavelengths of light operatively coupled with one optic input (15). In this manner, an optic input is coupled with one or more wavelengths of EMR that can be used for determining the analyte of a sample inserted within a receptor (30) of the device (35).

The EMR source of the device of the present invention may emit one or more than one wavelength of EMR. For example from 1 to 50 or more wavelengths may be used as required. As an example, the source of EMR may emit one or more wavelength of EMR over a range of wavelengths from about 300 nm to about 20,000 nm, or any wavelength therebetween as desired. For example, from about 300 to about 3000 nm, or any wavelength therebetween, or from about 500 nm to about 2500 nm or any wavelength therebetween. The source of EMR may be any suitable source, such as a laser source, an LED source, a monochromatic source, a polychromatic source or another suitable source of EMR for irradiating a sample at one or more than one desired wavelengths.

The infrared region of the electromagnetic spectrum is generally considered to be the spectral interval extending from 650 nm through to 1 mm. Measurement of samples using the near-infrared region may be obtained from about 700 nm to about 1100 nm range. Absorption bands observed in this interval are primarily the combination and overtone bands of the fundamental infrared bands. Although very weak in intensity, being typically less than one-tenth in intensity of the fundamental infrared bands, these bands are considered to be analytically useful because nearly all chemical species exhibit characteristic absorption bands in this spectral interval. The near infrared region is particularly well-suited to invasive and non-invasive diagnostic applications because biological samples, or human tissue are somewhat transparent to the incident radiation and therefore sufficient penetration of the radiation is possible to allow accurate quantitative analysis.

Use of other ranges of EMR is also contemplated, for example, the shortwave infrared (SWIR)—about 1400 to about 3000 nm; the mid-wavelength infrared (MWIR)—about 1400 nm to about 3000 nm; ultraviolet range—about 10 to about 400 nm; or visible range—about 400 to about 700 nm.

The source of EMR (10), and the range of wavelengths emitted by the EMR source is not to be considered limiting in the present invention. As an example, a polychromatic light source may be used. This type of light source can emit light over a wide bandwidth, including light in the near infrared spectrum. Light from the light source (10) may be passed first through a collimator (22)—a collection of lenses that concentrates the light into one or more narrow, parallel beams, directed at the receptor (30) via the optic input (15). The polychromatic light source may comprise a quartz-halogen or a tungsten-halogen bulb to provide the broad spectrum of light in the near infrared, and may be powered by a stabilized power source (20), for example, a DC power supply, or by a battery. This polychromatic light source may be a tungsten-halogen lamp or it may be a collection of LEDs or other light sources selected to emit radiation in, for example, the near-infrared range of about 650 to about 1100 nm. More particularly, the polychromatic light source comprises a source of light that emits a wavelength of light in the visible red spectrum, for example, 660 nm, a wavelength of light in the infrared spectrum, for example, 940 nm, and a broad spectrum of light in the near infrared region.

The EMR produced by the EMR source (10) may be filtered to provide discrete incident beams with a defined wavelength range. Each of the discrete incident beams are provide to the receptor (30) to detect the one or more than one compounds or analytes in the sample wells (54) of the sample holder (50).

The device (35) may have one or more receptors (30). If the device has multiple receptors, each receptor may be configured to have a different cross-sectional area so that it is only able to receive a sample holder (50) comprising a corresponding cross sectional shape (see FIG. 1A). In this manner, specific EMR wavelengths may be directed to a sample within the appropriate sample holder so that a desired analyte or set of analytes within the sample may be determined. Any suitable cross-sectional area or profile of a sample holder (50) and receptor may be used, for example, a square, a rectangle, a trapezoid, a circle, an oval, a triangle, a polygon having from 5 to about 20 sides, and the like. Each sample holder (50) may be configured to comprise a different path length best suited for the analyte being identified, quantified, or both identified and quantified. The sample holders (50) and receptors (30), may be colour coded, in addition to having complimentary cross-sectional areas or profiles to facilitate insertion within the appropriate receptor (30).

If the device (35) comprises one receptor (30), then the receptor may be designed to receive a plurality of sample holders (50) with either different cross-sectional areas, or of different lengths or widths. In this way, insertion of one sample holder (50) having a specific cross-sectional profile, length or width, and if desired having a different path length, for example a circular cross-section area, or a length X, will activate one set of wavelengths, for example 678 nm and 721 nm, and insertion of a second sample holder (50), having a different cross-sectional area width or length, for example a trapezoid cross-section area, or length Y, will activate a second set of wavelengths, for example 678 nm and 452 nm. In this way, for example, a sample of blood may be analyzed in one sample holder (50), when inserted into the receptor (30), and urine analyzed in a second sample holder (50) when inserted within the same receptor (30), or the same sample inserted within the two sample holders may be analyzed for different analytes using one receptor (30). One or more optic inputs (15) may be directed to the one receptor (30), the optic input operatively associate with the EMR source (10) to carry a specified wavelength or combination of wavelengths of EMR as determined by the sample holder (50) inserted within the receptor (30). The wavelength, of combination of wavelengths of EMR that are transmitted through the optic input (15) may be selected using any selection mechanism as would be known in the art, for example, which is not to be considered limiting, a different micro-switch may be activated by insertion of each sample holder (50) into the receptor, or insertion of the sample holder (50) may disrupt or reflect a reference beam of EMR within the receptor and activate a corresponding wavelength or set of wavelengths of EMR to be transmitted through the optic input (15).

The receptor (30) may be configured to receive multiple sample holders (50), where each sample holder when inserted within the receptor (30), is positioned and in optical alignment or operatively coupled with a specific optic input (15)-optic output (25) pair, and selects the appropriate wavelength of EMR to determine information about the target analyte within a sample in the sample holder. This arrangement ensures that each sample holder (50) is exposed to one or more select EMR wavelength(s) as required to determine an analyte of interest within the sample. For example the receptor may be configured to receive from 1 to 10, or any number therebetween, or more than 10, different sample holders, each sample holder comprising different identifiers, cross sectional profiles, tabs, colours, bar codes, or other holder-specific identifiers (described in more detail below) that activate one or more desired wavelength of EMR to be emitted by the device for that sample holder. For example the receptor may be configured to receive from 1, 2, 3, 4, 5, 6, 7, 8, 9, 10, or any number therebetween, or more, different sample holders, and be capable of altering the wavelength of EMR to be emitted that corresponds to the sample holder inserted into the receptor. The device may therefore be configured to pass EMR wavelengths through each of the 1 to 10 or any number therebetween, or more, of the sample holders. This may be done using from 1 to 10 or more optic input-optic output pairs, or any number therebetween, and using from 1 to 10, or any number therebetween, or more, different wavelengths of EMR. With this configuration, different analytes within a sample may be analyzed, depending upon the identifier of the sample holder, and additional information about the analyte determined as required, or different samples may be analyzed for the same or different analytes, depending upon the identifier of the sample holder, and additional information about the analyte(s) determined as required. The identifier associated with the sample holder may also be scanned or read by the device prior to inserting the sample holder into the receptor. In this way one receptor and one sample holder may be used by the device, yet multiple analytes within a sample or samples maybe determined by the device based on the wavelength selected using the identifier.

As noted in more detail below, the sample holder (50) may be a multiport sample holder and comprise multiple sample wells (54; FIGS. 4A and 4B), where each sample well, when the multiport sample holder (50) is inserted within the receptor (30), is positioned and in optical alignment or operatively coupled with a specific optic input (15)-optic output (25) pair. This arrangement ensures that each sample well (54) is exposed to one or more select EMR wavelength(s) as required to determine an analyte of interest within the sample. For example the multiport sample holder may comprise from 1 to 50, or more, sample wells, or any amount therebetween, for example 1, 2, 3, 4, 5, 6, 7, 8, 9, 10, 12, 14, 16, 18, 20, 22, 24, 26, 28, 30, 32, 24, 26, 28, 40, 42, 44, 46, 48, 50 wells, or any number therebetween. The device may therefore be configured to pass EMR wavelengths through each of the 1 to 50 or more sample wells or any number therebetween, and comprise from 1 to 50 or more optic input-optic output pairs, or any number therebetween. For example the device may comprise from 1, 2, 3, 4, 5, 6, 7, 8, 9, 10, 12, 14, 16, 18, 20, 22, 24, 26, 28, 30, 32, 24, 26, 28, 40, 42, 44, 46, 48, 50 or any number therebetween, optic input-optic output pairs, and may be configured to introduce either the same wavelength of EMR to each of the 1 to 50 or more sample wells, or from 1 to 50 or more different wavelengths of EMR though each of the 1 to 50 or more optic input-optic output pairs or any number therebetween, and 1 to 50 or more sample wells, or any number therebetween, for example 1, 2, 3, 4, 5, 6, 7, 8, 9, 10, 12, 14, 16, 18, 20, 22, 24, 26, 28, 30, 32, 24, 26, 28, 40, 42, 44, 46, 48, 50 or any number therebetween of different wavelengths may be used. With this configuration, multiple analytes within a sample may be identified and additional information about the analyte determined. With this sample holder comprising multiple wells (50), one sample is used and portions of the sample, located in each well (54) are subject to different EMR wavelengths for the determination of different analytes within the sample. Each well may comprise the same or different pathlengths, as required.

By placing the sample within a receptor (30), or by ensuring that specific wavelengths of EMR are directed to specific sample wells (54), one or more wavelength of EMR may be selected and used for determination of an analyte within the sample. For example, one of the receptors (30) may be configured to receive a sample holder (50) having a set path-length and when the sample holder is inserted in the specific receptor (30), a pre-set one or more wavelengths of EMR is used to determine the identity/concentration of the analyte in the sample. A receptor (30) may be configured for a different pre-set one or more wavelengths of EMR, and a similar or different path-length as needed for the identification/concentration of an additional analyte in a sample. The samples being analyzed in the different sample holders may be the same or different. Additionally, when a multiport sample holder is used, specific wavelengths of EMR may be directed to specific sample wells (54), so that one or more wavelength of EMR is selected and used for determination of one or more analytes within the sample.

There may be one receptor (30) of the device (35), and this receptor configured to receive one sample holder (50) at a time, however, each of the sample holders may be of a variety of different cross-sectional shapes. The receptor (30) is of a size and configuration to be able to receive each appropriately-shaped sample holder (50). The type of sample holder (50) inserted within the receptor (30) will activate a pre-set one or more wavelength(s) of EMR specific for an analyte within the sample that is associated with the sample holder used. For example, which is not to be considered limiting, a sample holder (50) having a square cross-sectional profile may be used for the identification and quantification of a bacterial analyte within a sample, while a sample holder having a trapezoidal cross-section may be used to determine the concentration of blood Hb.

By sample it is meant a biological or non-biological fluid, a biological or non-biological semi-solid, or a biological or non-biological solid exhibiting one or more properties that may be measured spectroscopically. A sample typically comprises one or more than one analytes. Examples of a sample include, but are not limited to, a calibrator, water, whole blood, serum, plasma, urine, synovial fluid, lymphatic fluid, sputum, feces, cerebrospinal fluid, dairy products, milk, cheese, yogurt, ice cream, wine, or beverages, semi soft food.

By sample holder (50) it is meant a transparent or translucent container capable of holding a sample to enable measurement of absorbance, reflectance, or both absorbance and reflectance of EMR from the sample. The sample holder is of a shape, size and cross-sectional area or profile that it may be inserted within a receptor (30) of the device (35).

By analyte it is meant a substance, compound or organism being measured in a sample, and includes a pathogen, a bacteria, a nosocomial pathogen, food or waterborne pathogens, opportunistic pathogens, or another microbe. For example, which is not to be considered limiting, an analyte may include: Listeria monocytogenes, Salmonella spp, Clostridium spp. Escherichia coli O157:H7, Vibrio spp. Campylobacter spp., Pseudomonas spp, Bacillus spp, Cyanobacteria, Cryptosporidium, Legionella spp., Aeromonas spp., or the like. An analyte may also include a carbohydrate, a protein, a glycoprotein, hemoglobin, Oxy-Hb, % oxy-Hb, “Oxy-Hb plus Deoxy-Hb”, “Total-Hb minus Met-Hb”, Met-Hb, % met-Hb, Carboxy-Hb, Co—Hb, Sulf-Hb, HbA_{1c}, cholesterol, glucose, a lipoprotein, a steroid, an amino acid, nitrogen, carbon dioxide, cortisol, creatine, creatinine, a ketone, a lipid, urea, a fatty acid, glycosolated hemoglobin, alcohol, lactate, an ion, Ca²⁺, K⁺, Cl⁻, HCO₃⁻, HPO₄⁻ and a neutral or ionic form of a heavy metal, for example, but not limited to a neutral or ionic form of a metal having an atomic number greater than 20 (calcium), more particularly a metal having an atomic number between 21 (scandium) and 92 (uranium), such as a neutral or ionic form of mercury, arsenic, lead or cadmium, a fatty acid for example an omega-3 fatty acid, for example, but not limited to a-linolenic acid, eicosapentaenoic acid, or docosahexaenoic acid; an omega-6 fatty acid, for example, but not limited to linoleic acid, gamma-linolenic acid, eicosadienoic acid, dihomo-gamma-linolenic acid, arachidonic acid, docosadienoic acid, adrenic acid, or docosapentaenoic acid; or an omega-9 fatty acid, for example, but not limited to oleic acid, eicosenoic acid, mead acid, erucic acid or nervonic acid), glycosolated hemoglobin, alcohol, lactate, an ion, Ca²⁺, K⁺, Cl⁻, HCO₃⁻, HPO₄⁻, and an antioxidant [such as Vitamin A (Retinol), Vitamin C (Ascorbic acid), Vitamin E (for example but not limited to alpha-, beta-, gamma- or delta-tocopherol; or alpha-, beta-, gamma- or delta-tocotrienol), a vitamin cofactor (for example but not limited to Coenzyme Q10 (CoQ10) or manganese), a hormone (for example but not limited to melatonin), a carotenoid terpenoid (for example but not limited to lycopene, lutein, alpha-carotene, beta-carotene, zeaxanthin, astaxanthin, or canthaxantin), a non-carotenoid terpenoid (for example but not limited to eugenol), a flavonol (for example but not limited to resveratrol, pterostilbene, kaempferol, myricetin, isorhamnetin, proanthocyanidins, or condensed tannins), a flavone (for example but not limited to quercetin, luteolin, apigenin, or tangeritin), a flavanone (for example but not limited to hesperetin, naringenin, or eriodictyol), a flavan-3-ol (for example but not limited to catechin, gallocatechin, epicatechin and its gallate forms, epigallocatechin and its gallate forms, theaflavin and its gallate forms, or thearubigins), isoflavone phytoestrogens (for example but not limited to genistein, daidzein, or glycitein), anthocyanins (for example but not limited to cyanidin, delphinidin, malvidin, pelargonidin, peonidin, or petunidin), phenolic acids and their esters (for example but not limited to ellagic acid, gallic acid, salicylic acid, rosmarinic acid, cinnamic acid and its derivatives, chlorogenic acid, chicoric acid, gallotannins, or ellagitannins), curcumin, anthoxanthins, betacyanins, silymarin, or citric acid.

The analyte may be detected using reagent-based analysis, or spectroscopy-based analysis, as would be known in the art.

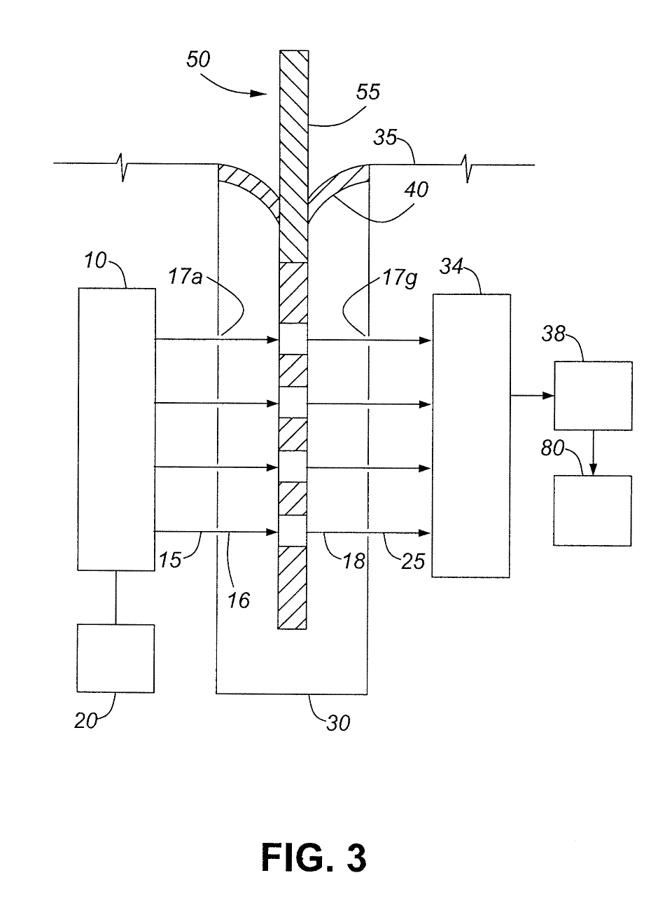

An alternate device (35) comprising a multiport sample holder (50) is shown in FIG. 3. In this example the device (35) comprises a source of electromagnetic radiation (EMR; 10), a receptor (30) within a housing of the device (35), and a detector (34), wherein the source of EMR (10), the receptor (30), and the detector (34) are in an operative optical association, so that a path of EMR from the source of the EMR (10), through the receptor (30) to the detector (34) may be established. The detector (34) is operatively coupled with a processing system (38) that comprises a microprocessor. The output from the processing system is transmitted to a data storage device (80). The processing system (38) and data storage (80) may be located within the device (35), or they may be located at a distance from the device and the processing system (38) either hard-wired to the detector (34), or the processing system may be in wireless communication with the detector of the device.

The path of the EMR through the housing is guided from the EMR source to the receptor by an optic input (15), and from the receptor to the detector by an optic output (25). Entrance of the incident EMR beam (16) to the receptor is facilitated by input port (17a); similarly, exit of the reflected and/or refracted EMR beam (18) is facilitated by output port (17g). When a sample holder (50) is placed within the receptor (50), a plurality of wells (54) in the sample holder (50) are in line with corresponding optic input (15)-optic output (25) pairs. The device (35) may optionally include flexible light shields (40) at the entrance of the receptor (30), to minimize interference of scattered or stray light, and/or prevent ambient light from interfering with the EMR transmission in the receptor (30) and through the sample holder (50).

An example of a single well sample holder is shown in FIG. 1A, and an example of several multi-well sample holders (50) is illustrated in FIGS. 4A and 4B. The sample holder (50) typically comprises a gripping surface (55) for ease of handling, and a sample input port (52) for loading the sample. The sample may be loaded by injection, for example, from a syringe, or with a pipette or similar device for transferring small liquid volumes, or by capillary action. Sample wells (54) may be in fluid communication with the sample inlet (52) and each other by conduits (56), and if desired include an overflow/vent (57), that allows for escape of air as the chambers are filled. The sides, or ‘windows’ of the sample holders, where the EMR passes to irradiate the sample, comprise material that is EMR-transparent. For example, for near-infrared EMR, SiO₂ may be used for sample well windows, while for ultraviolet EMR, ultraviolet-transparent material may be used for sample well windows. For visible light EMR, glass or clear polymer, for example a clear plastic, may be suitable for a sample well window. Selection of a suitable material will be within the ability of one skilled in the art, upon consideration of the appropriate EMR wavelength(s) to be used.

EMR of varying wavelength reflected and/or transmitted by the compounds in the sample well (54), when detected by the array of pixels within the detector (34), generates a pattern, or fingerprint that is unique to the combination of incident EMR, compound in the sample and the EMR refracted and/or reflected by the compound. Such patterns or fingerprints may be generated under test conditions, and the resulting pattern stored for later access, e.g. for comparison to a fingerprint obtained from a sample. Commercially available library of spectra, allowing identification of an unknown substance may also be used; such a library may be used to identify relatively simple chemical compounds, as well as more complex compositions such as microbes, bacterial or the like (see, for example U.S. Pat. No. 5,112,745).

In an alternative embodiment, if an error is observed in the analysis of the sample, the processing system (38) may trigger the device (35) to issue a warning signal, light, alarm and the like in order to notify the user of the problem. Non-limiting examples of errors that may result in a warning include, an incorrect type of sample holder (50) placed within a receptor (35), partially filled sample holder (50), or partially filled sample wells (54), incident light entering the receptor (30), incorrect positioning of the sample holder (50) within the receptor (30) so that the optic input (15) and optic output (25) are not in alignment with a sample well (54), incomplete measurement of the sample (e.g. the sample holder was removed in advance of EMR transmission and signal processing), or there is a fault with power source (20), EMR source (10), detector (34), processing system (38), transmitter (46; if present), data storage (80; e.g. if it is full), or other component of the device (35).

In a further alternative embodiment, each sample holder (50) may comprise an identifier that can be detected by the device (35) by a detection device suitable to detect the identifier. For example, a detection device may include a bar code reader, radio frequency identification reader, magnetic stripe reader. The detection device may be a separate device, or incorporated within the detector (34). The identifier may be used by the device (35) to identify and track each sample holder (50) or detect if a user is attempting to reuse the same sample holder (50) for more than one measurement. The identifier may comprise a unique identifier, such as, for example, one or more bar codes, radio frequency identification tags each having a unique identifier, magnetic stripes, or other unique identifiers that may be read by the detection device, for example, a tab, an opening or set of openings. Alternatively, the identifier may comprise a non-unique identifier indicating whether the sample holder (50) has already been used to measure a sample in the device (35), such as, for example, a portion of the sample holder (50) that is removed, marked, deformed, hole punched, or modified, or other non-unique identifiers. Additionally, the identifier may comprise a particular combination of the presence or absence of samples at particular locations (within specific sample wells; 54) on the sample holders (50) which can be detected by the detection device or detector (34) or other suitable detection device. The identifier may also be scanned or read by the device prior to inserting the sample holder into the receptor. Alternatively, the device may comprise a set of buttons, toggles or touch screen prompts to select a desired wavelength of EMR to be emitted for analyte determination.

The device (35) may also comprise an identifier to identify a specific user or device owner, so as to ensure privacy or security of the data that is obtained by the device and either retained on the device (35), transmitted to an offsite processing system (38), or transmitted to an office data storage (80) facility. Furthermore, one device may be used by multiple users or multiple patients, and each user or patient may have a unique identifier so that any data obtained from the user is logged against the appropriate user and if required accessible to the specific person using their unique identifier. The identifier may include a biometric scanner, for example a finger print reader or iris scanner, or it could include a password, bar code or other unique identifier.

All citations are herein incorporated by reference, as if each individual publication was specifically and individually indicated to be incorporated by reference herein and as though it were fully set forth herein. Citation of references herein is not to be construed nor considered as an admission that such references are prior art to the present invention.

One or more currently preferred embodiments of the invention have been described by way of example. The invention includes all embodiments, modifications and variations substantially as hereinbefore described and with reference to the examples and figures. It will be apparent to persons skilled in the art that a number of variations and modifications can be made without departing from the scope of the invention as defined in the claims. Examples of such modifications include the substitution of known equivalents for any aspect of the invention in order to achieve the same result in substantially the same way.

What is claimed is:

1. A device for obtaining information for one or more analytes in a sample, comprising,
an electromagnetic radiation (EMR) source operatively coupled to a power source, the EMR source in operative communication with one or more optic inputs, each of the one or more optic inputs emitting one or more wavelengths of EMR,
one or more receptors for receiving one or more sample holder, each of the one or more receptors comprising one or more of the one or more optic input operatively coupled to one or more optic output thereby forming an optic input-optic output pair, each of the optic input-optic output pair receiving one or more wavelengths of EMR,
a detector operatively coupled with each of the one or more optic output, the detector for measuring transmitted or reflected EMR received from a sample when placed in the sample holder and the sample holder placed within the receptor, the detector producing a signal output comprising the obtained information.

2. The device of claim 1 further comprising a processing system operatively coupled to the signal output, the processing system comprising one or more calibration algorithms for detecting the identity, concentration or a combination thereof of the one or more analytes in the sample.

3. The device of claim 2, wherein the processing system is operatively coupled to the signal output via a hard wire connection.

4. The device of claim 2 wherein the device further comprises a transmitter that receives the output signal and transmits the output signal via a wireless connection to a processing system.

5. The device of claim 2 further comprising a screen for displaying a result obtained from the processing system the result comprising the identity concentration, or a combination thereof of the one or more analytes in the sample.

6. The device of claim 1 wherein the device is portable, or hand-held.

7. The device of claim 1 wherein each of the one or more receptors comprises a different cross-sectional profile, and each of the cross-sectional profiles of the receptors corresponds to a corresponding cross-sectional profile of the sample holder.

8. The device of claim 1 wherein the detector comprises one or more pixels, each of the one or more pixels comprising a photodetector with a single-layer thin film, the thin film having a known absorption coefficient.

9. The device of claim 1 wherein each of the one or more receptors is shaped to receive one or more sample holders, each sample holder having a different cross-section profile, the one or more receptor further comprising one or more selection mechanism to activate a pre-set one or more wavelength of EMR to pass through a sample when the one or more sample holders is inserted within the receptor.

10. The device of claim 1 wherein the one or more receptors is shaped to receive one or more sample holders, each sample holder comprising a plurality of sample wells, each of the one or more optic input-optic output pairs within the one or more receptors positioned within the receptor to align with each of the plurality of sample wells of the sample holder when the sample holder is inserted into the receptor.

11. The device of claim 2, wherein each of the one or more receptors is configured to direct the one or more wavelengths of EMR towards each sample contained in each one or more sample holder based upon an identifier associated with each of the one or more sample holders.

12. The device of claim 2, wherein the device is configured to apply an identifier to each of the one or more sample holders inserted in the device; and reject sample holders that have been previously presented to the device.

13. A method for identifying one or more analyte in one or more sample, the method comprising, inserting each of the one or more sample into one or more sample holders, placing each of the one or more sample holders within each of the one or more receptors of the device of claim 2, and identifying the one or more analyte in the sample.

14. The method of claim 12, wherein the one or more analyte is a pathogen, a bacteria, or a compound.

15. The methods of claim 12, wherein the sample is a biological or non-biological fluid, a biological or non-biological semi-solid, or a biological or non-biological solid, a water sample, a sample of whole blood, serum, plasma, urine, synovial fluid, lymphatic fluid, sputum, feces, cerebrospinal fluid, a dairy product, milk, cheese, yogurt, ice cream, wine, a beverage, or semi soft food.
